(19) United States
(12) Patent Application Publication
(10) Pub. No.: US 2004/0090527 A1
(43) Pub. Date: May 13, 2004

(54) Providing information concerning an object in a picture

(75) Inventors: Dimitri Kanevsky, Ossining, NY (US); Clifford A. Pickover, Yorktown Heights, NY (US); Alexander Zlatsin, Yorktown Heights, NY (US)

Correspondence Address: PAUL D. GREELEY, ESQ., OHLANDT, GREELEY, RUGGIERO & PERLE, L.L.P., ONE LANDMARK SQUARE, 10th FLOOR, STAMFORD, CT, 06901-2682, US

(73) Assignee: INTERNATIONAL BUSINESS MACHINES CORPORATION

(21) Appl. No.: 10/609,769

(22) Filed: Jun. 30, 2003

Related U.S. Application Data
(62) Division of application No. 09/183,482, filed on Oct. 30, 1998, now abandoned.

(51) Int. Cl. H04N 5/225

(52) U.S. Cl. 348/207.1

(57) ABSTRACT

Various enhanced features for a digital camera that add to its functionality are disclosed. These features include interconnection capabilities that allow connecting the digital camera to telephones, modem lines, other digital cameras, watches, etc. By this feature, a digital camera display serves as an enhanced monitor or storage for a smart phone or watch. Another feature that is disclosed is that a digital camera can browse the Internet or content of other digital cameras and download pictures or other relevant information that depend on images that the digital camera captured. These downloaded images can be used as a background (or for other photo composing effects) while a user makes pictures from persons or other objects. These additional digital camera capacities can be useful for tourists especially if a digital camera can communicate via wireless channels.

### FIELD OF INVENTION

This invention relates to digital information exchange between digital cameras and other digital devices, such as telephones, watches, personal computers, network servers and the like. In particular, the invention relates to an improved digital camera and to methods that permit the digital camera to act as a display for devices with limited display capability and/or to act as an editor to edit and/or merge images to form a merged or edited image. The images may be pictures snapped by the digital camera or downloaded from other devices via a communication link. The invention also relates to a method for providing pictorial services.

### BACKGROUND OF THE INVENTION

Smart telephones add additional functions to a standard telephone. For example, the additional functions include a liquid crystal display (LCD), storage means for textual data, paging and limited browsing of the Internet. Paging is a function that exists in pagers to emit an audible signal or to receive a small textual message for display on a small LCD display. This function can be added to the improved digital camera and method of the present invention.

There are some disadvantages to smart telephones. For example, the telephone display and the telephone storage means are relatively small making it difficult to view or browse a large amount textual or graphical data. If the user of the smart phone does not have a computer available, a sufficient amount of information cannot be downloaded for later use.

Problems of a different kind are encountered by tourists. Some tourists would like to get information about places they are visiting or about objects they are viewing. For example, they may be viewing the Eiffel Tower and would like to know when and by whom it was constructed. They may see an unfamiliar building and would like to learn its identity. Professional photographers may be interested in learning what kind of pictures are already available for an object of interest. This information would be helpful for them to decide what different or similar picture to take.

In general, tourists can get help from an information bureau. However, information bureaus are not available at some locations or, if available, are sometimes overcrowded. A similar problem occurs when a tourist gets lost. Even with a telephone, a tourist may have difficulty describing precisely what object he/she is viewing or where he/she is located to get information or help.

A different kind of problem arises in cases where a digital camera user would like to have a different background in a picture being taken. Normally, photographers can edit a background after a picture is made, through use of elaborate equipment. This solution is unsatisfactory to users who prefer to compose a complete picture at the time it is being taken.

A common desire of digital camera users is to share different pictures between users. For example, to provide all members of a tourist group with pictures taken by all members, a sufficient number of copies of the pictures could be printed during or after the trip. However, this is wasteful of photographic prints and labor as each member generally desires only selected photographs.

### SUMMARY OF THE INVENTION

An object of the present invention is to provide a digital camera and method that enables digital information exchange between the digital camera and other digital devices.

Another object of the present invention is to provide a digital camera that is capable of acting as an enhanced display for a smart telephone or watch.

Another object of the present invention is to provide an improved digital camera and method for browsing the Internet or the storage means of other digital cameras.

Another object of the present invention is to provide an improved digital camera and method for processing downloaded images to provide photo composed effects.

An improved digital camera according to the present invention includes means for snapping a picture, a storage means, a display, an input means and a control means. To operate as a standard digital camera, the snapping means snaps a picture of an object that is stored as a first image in the storage means and is displayed on the display. The input means provides commands to the control means to obtain a second image over a communication link, to store the second image in the storage means and to display the second image on the display. The second image may be obtained from a device, such as a smart telephone or a digital watch, that has limited display and/or storage capability.

In another embodiment according to the present invention, the control means has an editing means that has photocomposition capabilities to modify the stored images and/or to form merged images. For example, the second image obtained via the communication link may be of the Eiffel Tower. The first image may be of family members. The editing facility is capable of merging the two images with the Eiffel Tower serving as a background for the family member image.

In a further embodiment according to the present invention, the control means has a browsing means that is capable of performing conventional browsing activities in a network, such as the Internet. For example, the second image can be obtained or downloaded from any server connected to the Internet. Conversely, the first or any other image stored in the digital camera storage means can be sent to any server on the Internet.

The communication link can connect the digital camera directly to another device or indirectly, via the Internet. For example, the digital camera can be directly connected to a personal computer for bi-directional transfer of images.

In still another embodiment according to the present invention, two or more digital cameras can be connected together to share stored pictures. That is, one digital camera can send its pictures to or can access and/or download the stored pictures of the other digital camera and vice versa.

In one method embodiment according to the present invention, the display capability of a device, such as a smart telephone or a digital watch having limited display capability, is enhanced. A communication link is established between the device and the digital camera. Data to be displayed is transferred from the device to the digital camera. The digital camera is operated to display the transferred data.

In another method embodiment according to the present invention, images are processed by a digital camera. Two or more images are stored in the storage means of the digital camera. The images may be pictures snapped by the digital camera or obtained via a communication link or any combination thereof. Input means are operated to provide commands. In response to the commands, one or more selected images are modified and/or merged to form a modified image that is stored and displayed on the digital camera display.

In a further method embodiment of the present invention, a pictorial service is provided. The method involves receiving from a requester a picture request concerning an object. A set of pictures contained in a data base is searched for a first picture of the object. Upon finding such first picture, a packet of information concerning the object is obtained and provided to the requester. The packet of information includes one or more items of the group that includes a geographic description, an historic description, a map, the first picture and/or other pictures of the object, nearby restaurants, hotels or other points of interest. For example, a tourist snaps a picture with a digital camera of the Eiffel Tower and desires information concerning its history, nearby hotels and restaurants. The tourist sends a picture request including the Eiffel Tower via the communication link to a provider of the pictorial service. The provider sends back the information packet containing the desired information.

In the various embodiments of the invention, the communication link may be either wired or wireless. The input means may be either wired or wireless.

In a still further embodiment of the present invention, the input means is a speech recognition facility that is voice activated.

### BRIEF DESCRIPTION OF DRAWINGS

Other and further objects, advantages and features of the present invention will be understood by reference to the following specification in conjunction with the accompanying drawings, in which like reference characters denote like elements of structure and:

FIG. 1 is a block diagram of a digital camera configured to exchange information with other devices;

FIG. 2 is a block diagram of a digital camera according to the present invention;

FIG. 3 is a block diagram of the controller for the FIG. 2 digital camera;

FIG. 4 is a block diagram of the facilities involved for the pictorial service method according to the present invention;

FIG. 5 is flow diagram of an editing procedure in a digital camera according to the present invention;

FIG. 6 is a block diagram of interconnected digital cameras according to the present invention; and

FIG. 7 is a block diagram of connections between a digital camera and a watch according to the present invention.

### DESCRIPTION OF PREFERRED EMBODIMENTS

A digital camera according to the present invention is a standard digital camera that is given additional functions. A standard digital camera is capable of acquiring, displaying and storing digital images. By combining the functions of photography and color separation scanning, a digital camera eliminates the time and cost of film processing. A typical digital camera has a resolution of 1.3 to 1.6 million pixels, a liquid crystal display with a size 3 inches by 4 inches and a 1 megabyte (MB) flash random access memory (RAM) for long term storage. A typical digital camera has a serial port for connection to a PC, a modem or a telephone set. This connection is made, for example, via a modular G-11 jack for a modem that exists in some telephone sets.

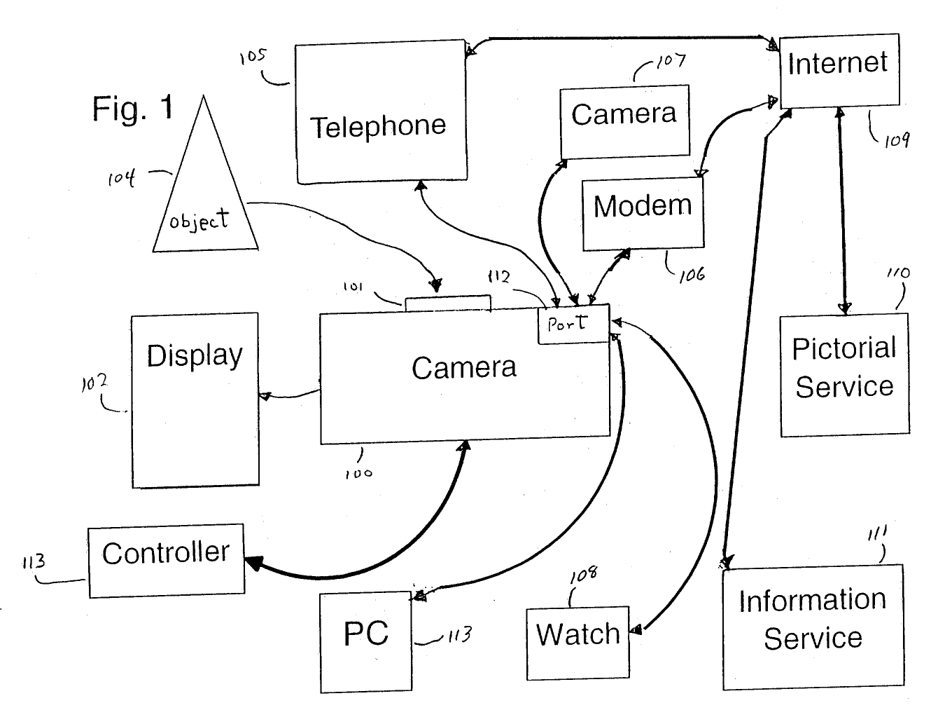

Referring to FIG. 1, a digital camera system that performs additional functions in accordance with the method and system of the present invention is designated by reference numeral 100. Typically digital camera 100 includes a lens 101 through which an object 104 is captured, an LCD display 102 on which digital camera pictures are displayed, a controller 103 that allows control of various digital camera functions and a serial port 112. Digital camera 100 may be connected via port 112 with various communication devices, such as a telephone 105, modem 106, and the like, or devices that can store data, such as another digital camera 107, a watch 108, a personal computer (PC) 113 and the like.

Telephone 105 and/or modem 106 can connect digital camera 100 to a network, shown as Internet 109. With digital camera 100 connected to Internet 109, a digital camera owner can browse Internet 109 or access a pictorial service 110. Pictorial service 110 provides a service that uses a picture or image taken by a tourist or user with digital camera 100. For example, an information service 111 can use pictorial service 110 to obtain information about a tourist's location, historic or geographic information, or provide additional pictorial components for photo effects.

Digital cameras 100 and 107, when connected together, permit sharing among the digital cameras of pictures stored in the two digital cameras.

Digital camera 100 can be connected to a device having limited display and/or storage capacity, such as telephone 105 or watch 108, to provide enhanced display and/or storage capability. For example, if telephone 105 is being used to browse and/or download data in textual or pictorial form from Internet 109, the limited display capacity of telephone 105 makes it difficult to view the data. This data can be downloaded to digital camera 100 for display on its display 102. Similarly enhanced viewing and/or storage of personal data can be provided by digital camera for personal data (e.g. telephone numbers) that are stored in watch 108. Some digital watches contain a calculator and one can use the digital camera display to view calculator data. Since a digital camera memory is usually larger than a watch memory, data can be moved from watch 108 to the memory of digital camera 100.

Digital camera 100, when connected to computer 113, can send and/or receive data to computer 113.

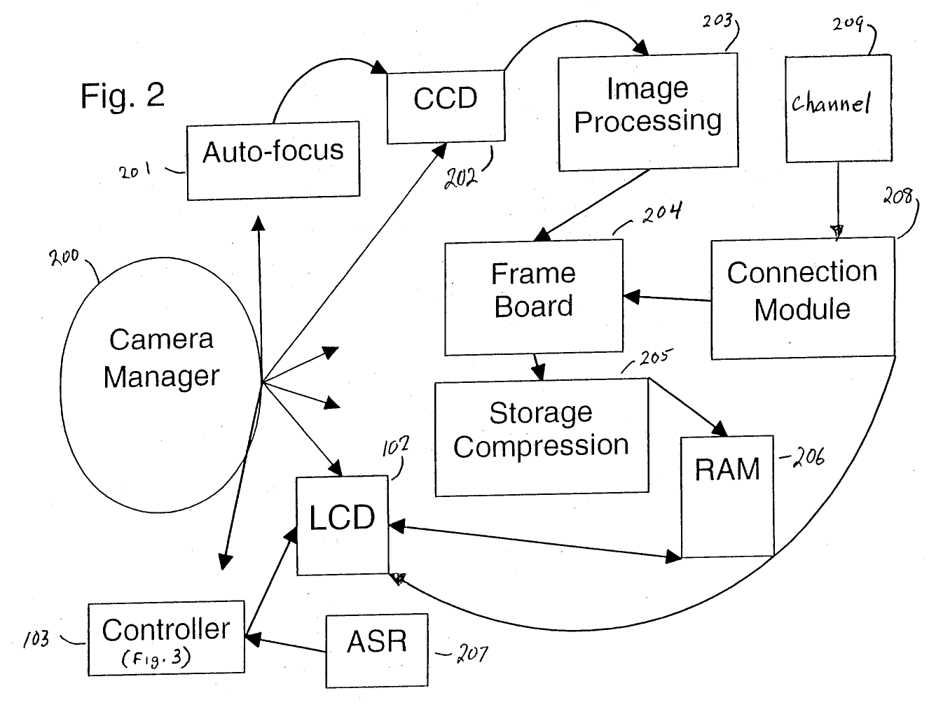

Referring to FIG. 2, digital camera 100 has a digital camera manager 200 that operates as a project manager for the digital camera and monitors all tasks taking place in the digital camera. For example, during power up, digital camera manager 200 checks that all major digital camera components are okay and ready to do their jobs. If any major component is not working, a message appears on display 102 and digital camera 100 stops working. If everything is okay, digital camera 100 is ready to take pictures (capture images) or to perform data transfer, browsing and/or editing functions in accordance with the present invention. Digital camera manager 200 is typically a semiconductor chip used in conventional digital cameras.

An auto-focus module 201 is operative during picture taking, to take a light reading and determine how long a digital camera shutter (not shown) should remain open and how much light is necessary.

When taking or snapping a picture of object 104, the shutter opens for the length of time specified by auto-focus module 201. A charged-coupled device (CCD) 202 captures light reflected from object 104 and stores that light as red, green and blue pixels. An image processing module 203 receives the pixels CCD 202 row by row in a serial fashion. Image processing module 203 processes the pixels for white balance, color, and aliasing correction. A frame board 204 puts the pixels back together in the form of a digital image.

A storage compression module 205 compresses the image to a level of compression that can be determined by a user.

Digital camera manager 200 generates a message to move the compressed image from storage compression module to a flash RAM 206 for long term storage. Typically RAM 206 contains 1 MB of memory space. Digital camera manager 200 then sends a message to display 102 to reduce the pictures remaining field (not shown) presented on display 102 by one.

Digital camera manager 200, auto-focus module 201, CCD 202, image processing module 203, frame board 204, storage compression module 205, RAM 206 and display 102 are conventional components of standard digital cameras.

In accordance with the present invention, a connection module 208, controller 103 and input device 207 are provided. Connection module or port 208 is responsible for communication between digital camera 100 and other devices. Connection module 208 contains serial port 112 that can be connected with serial ports of other devices as described above for FIG. 1.

Connection module 208 also has a communication protocol that enables reading a format in which data is received over a channel 209 that can be wired or wireless. This format specifies how data that is obtained over channel 209 is directed from connection module 208 to other components in digital camera 100. For example, connection module 208 can send an image obtained over channel 209 to frame board module 204 for formatting into a digital image similarly to digital images formatted from images of object 104 by image processing module 203. This path may be required for data downloaded from a server connected to Internet 109 or from digital watch 108.

Connection module 208 can send directly to flash RAM module 206 an image that is already in compressed form. For example, this option can be used when digital camera 100 is connected with another digital camera by a link established via channel 209. In such case, digital images received from digital camera 107 can be sent directly to RAM module 206 for storage and/or viewing on display 102. Connection module 208 also can send images stored in RAM 206 to digital camera 107 or to a server (e.g. information service 111) connected to Internet 109.

Controller 103 contains facilities to provide control over images displayed on display 102. Examples of tasks performed by controller 103 are editing images (for example, replacement of a background), browsing of Internet 109, searching storage means of devices to which digital camera 100 is connected, such as digital camera 107 or watch 108.

Input device 207 provides input commands to controller 103 to direct controller 103 to perform its tasks. Input device 207 can be any suitable input means such as a mouse, a keypad or a voice recognition device as designated by the initials ASR in FIG. 2.

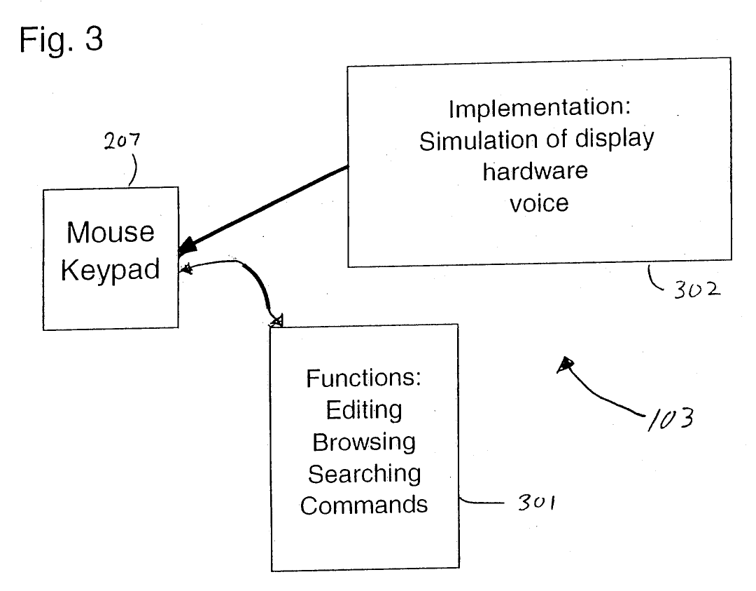

Referring to FIG. 3, controller module 103 in accordance with the method and system of the present invention receives input commands from input device 207 which is shown as a combination of a mouse and a keypad. A module 301 describes features or functions that can be performed by controller 103: editing, browsing, searching, typing commands and the like. A module 302 describes several ways for implementing features of module 300. These features can be implemented as hardware or software features or realized using speech recognition technology. Typically, a mouse is implemented as a hardware feature, for example, a small button that is inserted in digital camera 100. This button moves an arrow on display 102 in accordance with direction of a finger. Another button inserted in digital camera 100 is used to click when the arrow on display 102 is positioned on some drawn object, such as an icon. The design for such a mouse inserted in digital camera 100 is similar to a mouse inserted in a keyboard of a laptop computer, for example, a “Thinkpad” laptop that is produced by IBM.

A digital camera keypad can be implemented either as a set of buttons inserted in digital camera 100 or as a set of buttons that are presented on display 102 for point and click operation by the mouse. If digital camera 100 has ASR, then input control can be done via voice input.

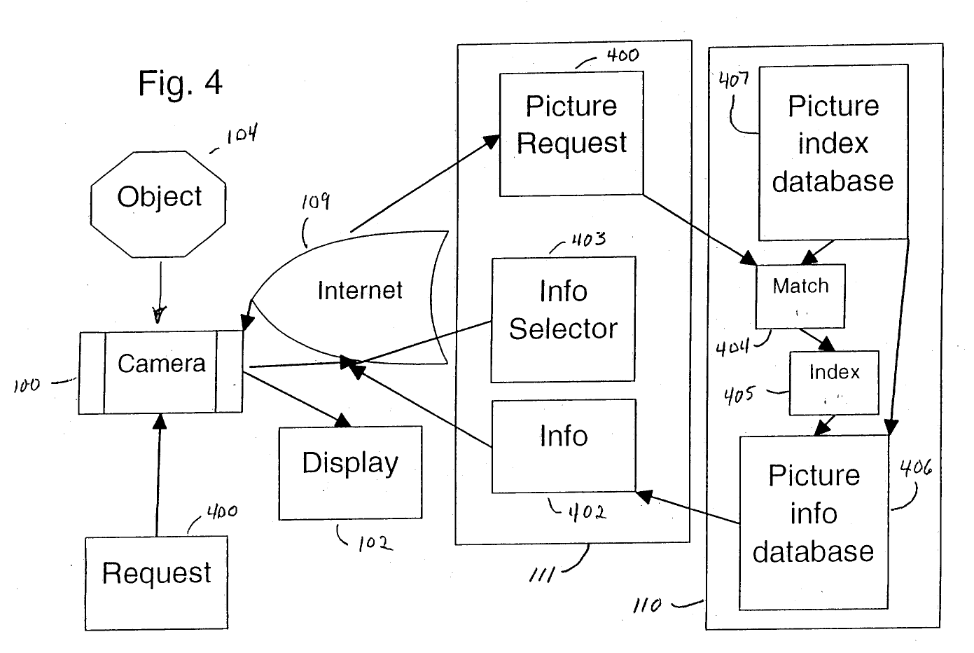

Referring to FIG. 4, one example of a pictorial service 110 will be described for the situation where a tourist wants to find a restaurant near his or her location. The tourist operates digital camera 100 to take a picture of object 104, for example, an historic building. The tourist enters into digital camera 100 a request 400 that contains the following items: name of a city of the tourist's location and a request for finding a restaurant. Controller 103 packages the picture of the building into request 400 and sends request 400 via Internet 109 to information service 111. Information service 111 sends the picture to pictorial service 110.

At pictorial service 110, the picture of request 400 is compared by a match module 404 with pictures contained in a picture index database 407. Database 407 contains pictures with indexes to information attached to each picture (that is, each picture points to some information related to this picture). This information includes, for example, geographic and historic descriptions related to objects that are contained in pictures and stored in picture index database 407. If match module 404 finds the match of the request picture in request 400 with some pictures stored in picture index database 407, an index 405 is produced. This index is used to access a set of descriptions related to this picture that is stored in a picture information database 406. This information is sent back to informational service 111 as an information package 402. Information service 111 extracts the information about a local restaurant from information package 402 (if it is available). Information service then sends the extracted restaurant information to digital camera 100 where it is displayed on display 102. Information service 111 can use automatic semantic methods or a human operator to interpret request 400. This information can be packaged, sent and displayed in the form of a map where the restaurant is marked.

There are various methods that are described in literature for matching images with a set of images stored in a database. For instance, content-based methods are described by J. Turel et al., “Search and Retrieval in Large Image Archives”, RC-20214(894230 Oct. 2, 1995, IBM Research Division T. J. Watson Research Center.

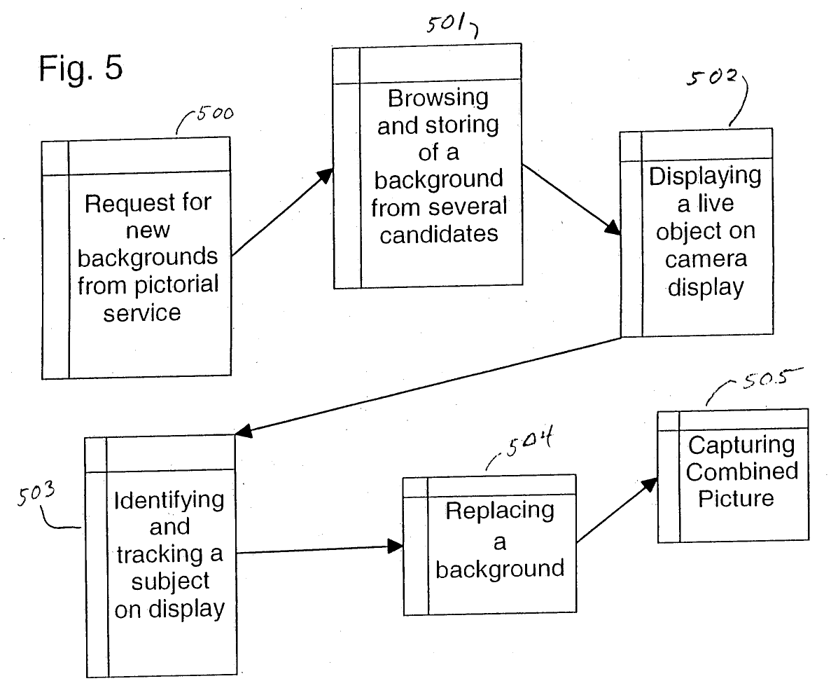

Referring to FIG. 5, there is illustrated an example of a procedure for capturing a subject by digital camera 100 with a background chosen from a picture database. Consider that a person in New York City wants to make a picture of a child with a background that contains the Eiffel Tower. Using digital camera 100, a request for this specific background is sent to a picture database 500 operated by a pictorial service. The pictorial service responds by returning to digital camera 100 a set of pictures containing the Eiffel Tower that are then displayed on display 102 of digital camera 100. The user views these pictures and selects one for storage in RAM 206 for use as the background at module 501. After the background is selected and stored in RAM 206, digital camera 100 is used to focus on the subject (the child) and to display this subject on display 102 as depicted at module 502. The picture displayed on display 102 contains the child on a live background that should be replaced with the Eiffel Tower background. To make the replacement, a child subject is identified on display 102 that will be tracked automatically by a digital camera module 503.

There are various known methods for specifying one subject among different objects that are presented in a picture. One can specify a subject by drawing a contour of this subject. One can also specify a subject by using a distance between the subject and the digital camera focus system (when digital camera focuses its lens, it uses an automatic means that allows a distance to be measured between a subject and the digital camera lens). A module 504 is operative to replace a live background with stored background (Eiffel Tower in our example). While backgrounds are replaced, the digital camera tracking system module 503 continues to keep the main live subject (the child in our example). If the view of the subject surrounded with the new background (the child near Eiffel Tower) is satisfactory, the digital camera button is actuated and module 505 responds to capture combined picture.

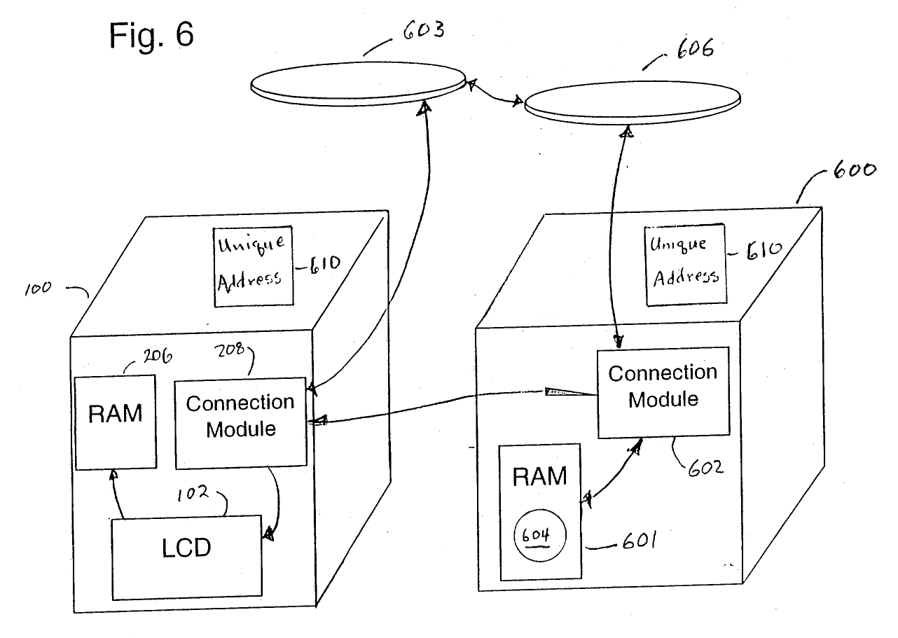

Referring to FIG. 6, digital camera 100 is interconnected with digital cameras 600, 603 and 606 for direct information exchange between two or more digital cameras. In current technology, it is not possible to exchange images between two or more digital cameras without intervening hardware such as wires, computers, and the like. According to the present invention, the serial port 112 (shown in FIG. 1) of the digital cameras allows one or more digital cameras to mate (i.e. directly connect) for the purpose of digital image transfer. The serial port may alternatively be equipped for communication among digital cameras 100, 600, 603 and 606 by wireless technology (for example, infrared) or by means of a network, such as the Internet.

In FIG. 6, each digital camera has an unique address 610. Using the addresses 610, any user can selectively download an image, such as an image 604 in digital camera 600 to any one or all of the other digital cameras connected in the network. For downloading to digital camera 100, image 604 is sent via a connection module 602 to digital camera 100 where it is received by a connection module 208 for presentation on display 102 in digital camera 100 and/or storage in RAM 206.

A user can give a digital camera 100, 600, 603 or 606 instructions for transfer of images by means of a graphical user interface (GUI). For example, a set of icons representing stored images in RAM 601 is displayed on display 102. A set of icons representing digital cameras 603 and 606 are also displayed. By using conventional drag and drop techniques, the user can drag an icon that represents an image to an icon that represents a specific camera to initiate a transfer of the image from one camera to another.

This direct interconnect is particularly useful in the field where wires and computers are not available. One can use a splitter of a serial port in a connection module 208 (or 602) in order to connect two digital cameras. If two digital cameras can be connected to one digital camera port, many digital cameras can be connected in one network. For example, in the network in the FIG. 6 digital camera 100 can be connected with digital camera 606 via digital camera 600. Serial ports can be equipped with male or female jacks. For example, all ports in digital cameras 100, 600, 603 and 606 can be male jacks and wires that connect to the ports can be female jacks.

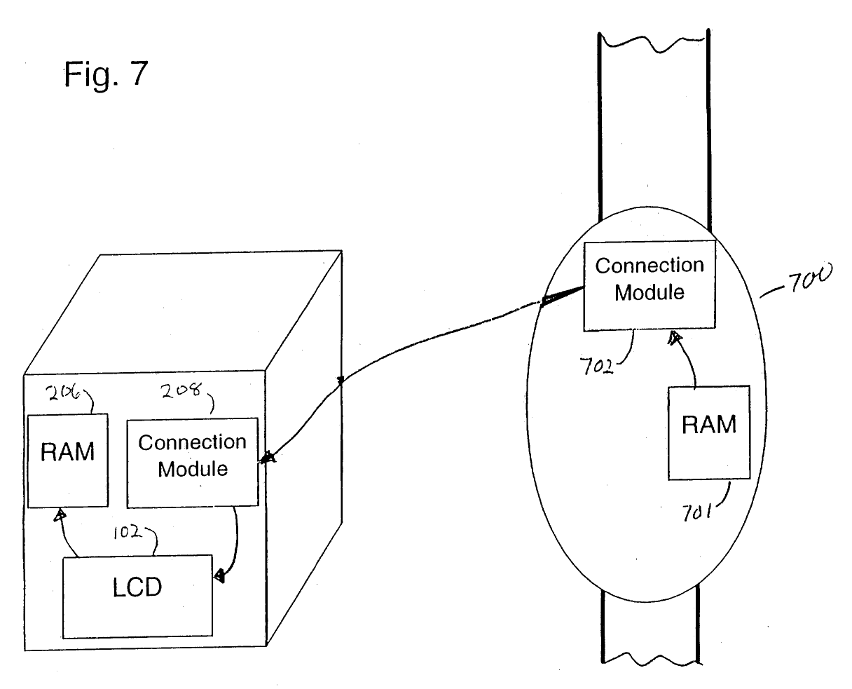

Referring to FIG. 7, digital camera 100 is connected to a wrist watch 700 via connection module 208 of digital camera 100 and connection module 702 in wrist watch 700. The contents of a RAM 701 of wrist watch 700 can be viewed on display 102 and downloaded to RAM 206 in digital camera 100.

The present invention having been thus described with particular reference to the preferred forms thereof, it will be obvious that various changes and modifications may be made therein without departing from the spirit and scope of the present invention as defined in the appended claims.

What is claimed is:

1. A digital camera comprising:
storage means;
means for forming a picture of an object as a first image in digital form;
means for storing images including said first image in said storage means;
display means for displaying images stored in said storage means;
input means for providing commands; and
control means responsive to said commands to connect said digital camera to obtain a second image over a communication link, to operate said means for storing to store said second image in said storage means and to operate said display to display said second image either in conjunction with or separate from said first image.

2. The digital camera according to claim 1, wherein one or more of said commands requires said control means to obtain said second image from a device that has a memory and a display of limited capacity, whereby said storage means and said display means serve as an enhanced storage means and display means for said device.

3. The digital camera according to claim 2, wherein said device is a telephone.

4. The digital camera according to claim 2, wherein said device is a watch.

5. The digital camera according to claim 1, wherein one or more of said commands requires said control means to obtain said second image from a personal computer.

6. The digital camera according to claim 1, wherein said control means contains an editing means for altering an image;
wherein one or more of said commands requires said editing means to edit one or both of said first and second images.

7. The digital camera according to claim 6, wherein one or more of said commands requires said editing means to edit said first image and said second image to form a merged image and requires said control means to operate said means for storing to store said merged image in said storage means and to operate said display to display said merged image.

8. The digital camera according to claim 6, wherein one or more of said commands requires said editing means to form said second image as a background for said first image that is later obtained by said picture snapping means.

9. The digital camera according to claim 1, wherein said control means includes a browsing means for enabling interaction with destinations connected in a network;
wherein one of said or more commands requires said control means to connect said digital camera to said network and requires said browsing means to perform a browsing operation of said network to obtain said second image from one of said network destinations.

10. The digital camera according to claim 9, wherein said network is the Internet; and
wherein one or more of said commands requires said control means to send one or more images stored in said storage means to an Internet destination.

11. The digital camera according to claim 1 wherein said communication link establishes a communication path between said digital camera and another digital camera; and
wherein said second image is obtained from said other digital camera.

12 The digital camera according to claim 11 wherein said commands require said control means to send one or more of said images stored in said storage means to said other digital camera via said communication path.

13. A method of providing a pictorial service to a digital camera, said method comprising:
receiving from said digital camera a picture and a request that concerns an object illustrated in said picture;
searching a set of pictures contained in a database for a first picture of said object;
upon finding said first picture, obtaining a packet of information concerning said object;
providing said packet of information to said digital camera.

14. The method according to claim 13, wherein said packet of information includes one or more items of the group that includes: a geographic description, an historic description, said first picture and/or other pictures of said object, or a map.

15. The method according to claim 14 that further comprises:
comparing said picture with said set of pictures for a match; and
upon finding a match, obtaining said packet of information.

16. The method according to claim 15, wherein said packet of information includes one or more items of the group that includes: a map, a geographic description, an historic description, said first picture and/or other pictures of said object, nearby restaurants, shops, hotels or other point of interest.

17. A method of enhancing the display capability of a device having a limited display capability, said method comprising:
establishing a communication link between said device and a digital camera that has a relatively larger display;
transferring from said device to said digital camera via said communication link data to be displayed; and
operating said digital camera to display images represented by said data on said larger display.

18. The method according to claim 17 wherein said device is a telephone.

19. The method according to claim 17 wherein said device is a watch.

20. A method of processing images with a digital camera, having a storage means, a display, an input means and a control means, said method comprising:
storing a first image in said storage means;
operating said input means to provide one or more commands;
responding to said commands to obtain a second image via a communication link and storing said second image in said storage means;
responding to said commands to edit said first and second images to form a merged image; and
displaying said merged image on said display of said digital camera.

21. The method according to claim 20 wherein said first image is a picture taken with said digital camera.
